(19) United States
(12) Patent Application Publication
(10) Pub. No.: US 2026/0208208 A1
(43) Pub. Date: Jul. 23, 2026

(54) ELECTRIC DUST-COLLECTING FILTER

(71) Applicant: Hanon Systems, Daejeon (KR)

(72) Inventors: Ji Yong PARK, Daejeon (KR); Jae Ho KIM, Daejeon (KR)

(73) Assignee: Hanon Systems, Daejeon (KR)

(21) Appl. No.: 19/157,325

(22) PCT Filed: Apr. 2, 2024
(86) PCT No.: PCT/KR2024/004235

§ 371 Date: Aug. 15, 2025

(30) Foreign Application Priority Data
Jun. 1, 2023 (KR) 10-2023-0070920

(51) Int. Cl. B03C 3/68; B03C 3/47

(52) U.S. Cl. CPC B03C 3/68; B03C 3/47; B03C 2201/30

(57) ABSTRACT

An electric dust filter is provided, which includes: a dust collection part configured to collect foreign substances that includes first and second electrode plates installed in one or more pairs on an air flow path leading to a vehicle interior so as to form an air flow path therebetween, the first and second electrode plates configured to generate an electric field in a specific direction therebetween using voltages with different magnitudes and collect foreign substances having a specific charge by an attractive force; and a control part configured to variably control the magnitudes of voltages applied to the first and second electrode plates according to a preset logic so that the attractive forces of the first and second electrode plates for the foreign substances having a specific charge can be alternately changed while reversing the direction of the electric field formed between the first and second electrode plates.

### TECHNICAL FIELD

The present invention relates to an electric dust filter, and more particularly, an electric dust filter in which the electric power application control structure of first and second electrode plates is improved so that both the first and second electrode plates can be used as dust collection parts, thereby improving the ability to remove a foreign substance in air blown into a vehicle interior and increasing the lifespan of a product.

### BACKGROUND ART

A vehicle is equipped with an air conditioner that controls the vehicle interior temperature.

The air conditioner takes in air existing inside and outside the vehicle, heats or cools the taken-in air to an optimal temperature, and blows the air into a vehicle interior.

It is important for the air conditioner not only to optimally control the vehicle interior temperature but also to maintain the quality of air in the vehicle interior at an optimal level.

In particular, the air in the vehicle interior is easily polluted due to the narrow and closed environment and the fine dust and various pollutants introduced from the outside. It is an important task to maintain the quality of air in the vehicle interior at an optimal level against the air pollution inside the vehicle interior.

As a means for improving the air quality in the vehicle interior, there is an electric dust filter that electrically removes foreign substances in the inside air and the outside air introduced into the vehicle interior to increase the cleanliness.

The electric dust filter charges various foreign substances in the air and then collects the charged foreign substances by electrical attraction. As shown in FIG. 1, the electric dust filter includes a charging part 10 that charges various foreign substances in the air blown into the vehicle interior with specific charges among negative charges and positive charges through corona discharge, and a collection part 20 that collects the charged foreign substances by electrical attraction. Hereinafter, a case where foreign substances in the air are charged with positive charges will be described as an example.

The collection part 20 includes first and second electrode plates 22 and 24 that are paired so that an air flow path 20a is formed between them.

The first and second electrode plates 22 and 24 are arranged in multiple pairs at regular intervals along the transverse direction of the air flow.

The collection part 20 applies a high voltage to one of the first and second electrode plates 22 and 24 and a relatively low voltage to the other. Hereinafter, a description will be given of an example in which a high voltage is applied to the first electrode plate 22 and a low voltage is applied to the second electrode plate 24.

Therefore, a strong electric field in a certain direction is generated between the first electrode plate 22 on the high voltage side and the second electrode plate 24 on the low voltage side, so that the first electrode plate 22 has a positive electrode property to generate a repulsive force against a positively charged foreign substance, and the second electrode plate 24 has a negative electrode property to generate an attractive force against a positively charged foreign substance.

Thus, the positively charged foreign substance in the air passing through the air path 20a between the first and second electrode plates 22 and 24 can be captured by the second electrode plate 24.

As a result, the foreign substances in the air blown into the vehicle interior are removed, thereby increasing the cleanliness of the air in the vehicle interior.

However, this conventional electric dust filter has a disadvantage in that, when the amount of foreign substances captured by the second electrode plate 24 reaches an excessively high level, the dust collection capability of the second electrode plate 24 is reduced.

In particular, as the amount of foreign substances captured by the second electrode plate 24 increases, the surface exposure of the second electrode plate 24 decreases due to the accumulated foreign substances.

In addition, due to this decrease in the amount of surface exposure, the attractive force of the second electrode plate 24 gradually weakens, and hence, the dust collection performance of the second electrode plate 24 is deteriorated.

Furthermore, as the amount of foreign substances captured by the second electrode plate 24 increases, the amount of foreign substances with a positive charge on the surface of the second electrode plate 24 gradually increases.

Due to these positively charged foreign substances, the voltage difference between the first electrode plate 22 and the second electrode plate 24 decreases, thereby weakening the electric field between them. Therefore, the positive electrode property of the second electrode plate 24 is weakened, which results in deterioration in dust collection performance.

Due to these shortcomings, the foreign substance processing capability of the second electrode plate 24 is significantly reduced.

As a result, there is a problem in that the purification capability of the electric dust filter for the air blown into the vehicle interior is significantly reduced, and the lifespan of a product is shortened.

### DETAILED DESCRIPTION OF THE INVENTION

### Technical Task

The present invention has been made to solve the above-mentioned problems of the prior art, and it is an object of the present invention to provide an electric dust filter in which the electric power application control structure of first and second electrode plates is improved so that first and second electrode plates can be used as dust collection parts.

Another object of the present invention is to provide an electric dust filter which is configured to use first and second electrode plates dust collection parts so that it becomes possible to significantly improve the ability to remove foreign substances in an air blown into a vehicle interior, thereby improving air purification performance.

A further object of the present invention is to provide an electric dust filter which is configured to enable first and second electrode plates to collect foreign substances so that it becomes possible to extend the lifespan of a product and reduce the manufacturing cost compared to the prior art that uses only the second electrode plate as a dust collection part.

### Means to Solve the Task

In order to achieve these objects, the present invention provides an electric dust filter, comprising: a dust collection part configured to collect foreign substances charged with a specific charge among negative and positive charges, the dust collection part including first and second electrode plates installed in one or more pairs on an air flow path leading to a vehicle interior so as to form an air flow path therebetween, the first and second electrode plates configured to generate an electric field in a specific direction therebetween using voltages with different magnitudes and collect foreign substances having a specific charge by an attractive force; and a control part configured to variably control the magnitudes of voltages applied to the first and second electrode plates according to a preset logic so that the attractive forces of the first and second electrode plates for the foreign substances having a specific charge can be alternately changed while reversing the direction of the electric field formed between the first and second electrode plates.

Depending on the direction of the electric field due to a voltage difference between the first and second electrode plates, one of the first and second electrode plates may have the same polarity as the foreign substances having a specific charge so as to generate a repulsive force while the other may have a polarity different from the polarity of the foreign substances having a specific charge so as to generate an attractive force, and the control part may be configured to apply a high voltage to one of the first and second electrode plates and a relatively low voltage to the other, and change the magnitudes of voltages applied to the first and second electrode plates according to a preset logic to reverse the direction of the electric field due to the voltage difference between the first and second electrode plates.

The control part may be configured to independently control the voltages applied to the first and second electrode plates to change the magnitudes of the voltages applied to the first and second electrode plates.

The control part may be configured to maintain the voltage applied to one of the first and second electrode plates at a constant value and variably control only the voltage applied to the other to reverse the magnitudes of the voltages applied to the first and second electrode plates.

### Effect of the Invention

According to the electric dust filter of the present invention, the voltages applied to the first and second electrode plates are controlled to periodically reverse the polarities of the first and second electrode plates, thereby alternately controlling the attractive force of the first and second electrode plates for foreign substances having a specific charge.

In addition, since the attractive force of the first and second electrode plates for foreign substances can be alternately controlled, both the first and second electrode plates can alternately collect foreign substances in the air blown into the vehicle interior.

In addition, since both the first and second electrode plates can be used as dust collection part, the ability to remove foreign substances in the air blown into the vehicle interior can be improved by about two times.

In addition, since both the first and second electrode plates can collect foreign substances, it is possible to extend the life of the product and to reduce the manufacturing cost compared to the related art in which only one of the first and second electrode plates is used as a dust collection part.

### BRIEF DESCRIPTION OF THE DRAWINGS

FIG. 1 is a view showing a conventional electric dust filter.

FIG. 2 is a view showing the configuration of an electric dust filter according to the present invention.

FIGS. 3A and 3B are views showing an example of the operation of an electric dust filter according to the present invention and showing a state in which the magnitudes of voltages applied to the first and second electrode plates are periodically reversed to periodically change the applied voltage difference between the first and second electrode plates and the electric field direction.

FIG. 4 is a view showing an example of the operation of the electric dust filter according to the present invention and showing a state in which foreign substances are captured on the first and second electrode plates when the applied voltage difference between the first and second electrode plates and the electric field direction are periodically changed.

FIGS. 5 to 11 are views showing a state in which the magnitudes of voltages applied to the first and second electrode plates of the electric dust filter according to the present invention are controlled to periodically change the applied voltage difference between the first and second electrode plates.

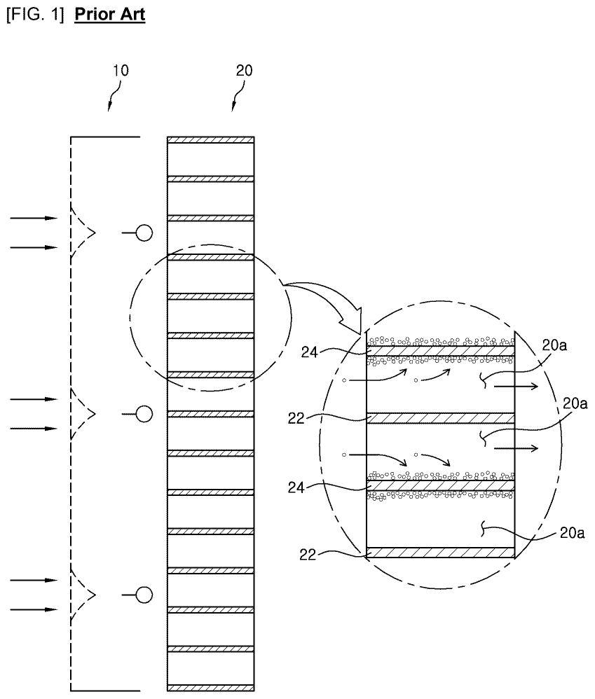

### BEST MODE TO IMPLEMENT THE INVENTION

Hereinafter, a preferred embodiment of an electric dust filter according to the present invention will be described in detail with reference to the accompanying drawings. The same components as those of the prior art described above are designated by like reference numerals.

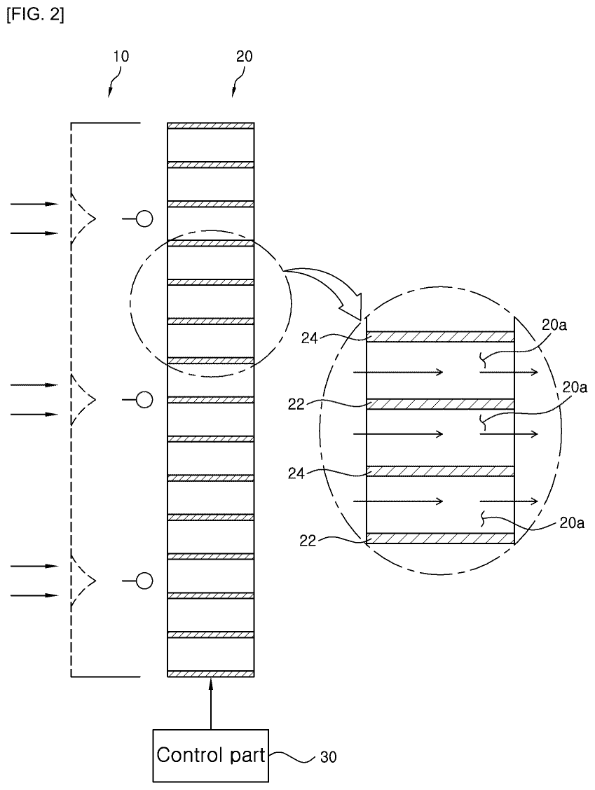

Prior to describing the features of the present invention, the electric dust filter will be briefly and generally described with reference to FIG. 2.

The electric dust filter is installed on an air flow path through which an air is blown into a vehicle interior, and includes a charging part 10 and a collection part 20.

The charging part 10 charges various foreign substances in the air blown into the vehicle interior with a specific charge among a negative charge and a positive charge through corona discharge.

The collection part 20 includes first and second electrode plates 22 and 24 that are paired so that an air flow path 20a is formed between them. The first and second electrode plates 22 and 24 are arranged in multiple pairs at regular intervals along the transverse direction of the air flow.

The collection part 20 applies a high voltage to one of the first and second electrode plates 22 and 24 and a relatively low voltage to the other.

Therefore, a strong electric field in a certain direction is generated between the first electrode plate 22 and the second electrode plate 24, so that one of the first and second electrode plates 22 and 24 has the same polarity as the foreign substance charged with a specific charge by the charging part 10 to generate a repulsive force, and the other has a polarity different from the polarity of the foreign substance charged with a specific charge to generate an attractive force.

Thus, the foreign substances having a specific charge and passing through the air flow path 20a between the first electrode plate 22 and the second electrode plate 24 can be captured by the electrode plate having a polarity different from the polarity of the foreign substances among the first and second electrode plates 22 and 24.

As a result, the foreign substances in the air blown into the vehicle interior can be removed, thereby increasing the cleanliness of the air.

Next, the features of the electric dust filter according to the present invention will be described in detail with reference to FIGS. 2 to 11.

Referring first to FIG. 2, the electric dust filter according to the present invention includes a control part 30 configured to variably control the magnitude of the voltage applied to the first electrode plate 22 and the second electrode plate 24 of the collection part 20 according to a preset logic.

The control part 30, which is equipped with a power supply part (not shown) and a microprocessor, applies voltages to the first and second electrode plates 22 and 24 of the collection part 20, and controls the magnitudes of the voltages applied to the first and second electrode plates 22 and 24 to be periodically changed at preset time intervals.

In particular, by periodically reversing the magnitudes of the voltages applied to the first and second electrode plates 22 and 24, it is possible to periodically change a voltage height between the first electrode plate 22 and the second electrode plate 24.

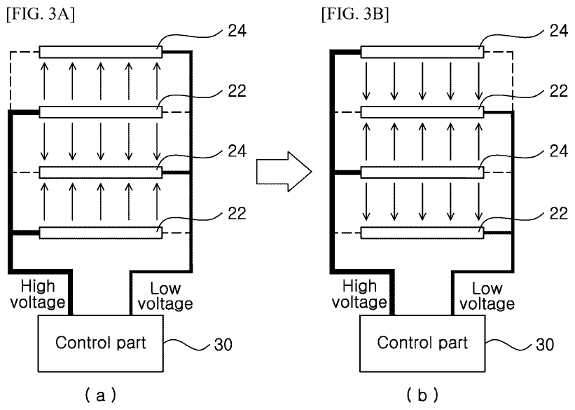

For example, as shown in FIG. 3, a high voltage of a specific magnitude is initially applied to the first electrode plate 22, and a low voltage of a magnitude lower than the magnitude of the voltage applied to the first electrode plate 22 is applied to the second electrode plate 24. After a preset time has elapsed in this state, a low voltage lower than the voltage applied to the second electrode plate 24 is applied to the first electrode plate 22, and a high voltage higher than the voltage applied to the first electrode plate 22 is applied to the second electrode plate 24.

Accordingly, the magnitudes of the voltages applied to the first electrode plate 22 and the second electrode plate 24 can be changed with each other.

In addition, the mutual reversal of the magnitudes of the voltages applied to the first and second electrode plates 22 and 24 is controlled to be periodically repeated at preset time intervals.

Therefore, as the voltage difference between the first and second electrode plates 22 and 24 is periodically changed, the direction of the electric field formed between the first and second electrode plates 22 and 24 is also periodically reversed at regular time intervals.

That is, when the voltage applied to the first electrode plate 22 is higher than the voltage applied to the second electrode plate 24 as shown in FIG. 3A, an electric field is formed between the first and second electrode plates 22 and 24 to flow from the high-voltage first electrode plate 22 side to the low-voltage second electrode plate 24 side.

Conversely, when the voltage applied to the second electrode plate 24 is higher than the voltage applied to the first electrode plate 22 as shown in FIG. 3B, an electric field is formed between the first and second electrode plates 22 and 24 to flow from the high-voltage second electrode plate 24 side to the low-voltage first electrode plate 22 side.

Therefore, when the magnitudes of the voltages applied to the first and second electrode plates 22 and 24 are periodically reversed, the direction of the electric field formed between the first and second electrode plates 22 and 24 is also be periodically reversed at regular time intervals.

Meanwhile, as the direction of the electric field formed between the first and second electrode plates 22 and 24 is periodically reversed at a certain time interval, the polarities of the first electrode plate 22 and the second electrode plate 24 are also periodically reversed according to the timing of the reversal of the direction of the electric field.

That is, when the electric field flows from the high-voltage first electrode plate 22 side to the low-voltage second electrode plate 24 side as shown in FIG. 3A, the first electrode plate 22 becomes positive and the second electrode plate 24 becomes negative.

Conversely, when the electric field flows from the high-voltage second electrode plate 24 side to the low-voltage first electrode plate 22 side as shown in FIG. 3B, the first electrode plate 22 becomes negative and the second electrode plate 24 becomes positive.

Accordingly, when the magnitudes of the voltages applied to the first and second electrode plates 22 and 24 are periodically reversed, and hence the direction of the electric field between the first and second electrode plates 22 and 24 is periodically reversed, the polarities of the first and second electrode plates 22 and 24 are mutually reversed and alternately changed between anode and cathode.

Meanwhile, the first and second electrode plates 22 and 24, the polarities of which are periodically reversed, have alternately changing polarities which are the same as and different from the polarity of the foreign substance charged with a specific charge by the charging part 10 (see FIG. 2).

Accordingly, the first and second electrode plates 22 and 24 alternately have repulsive and attractive forces with respect to the foreign substance charged with a specific charge.

In particular, the first and second electrode plates 22 and 24 alternately have opposite polarities with respect to the specific charge of the foreign substance and alternately have attractive forces with respect to the foreign substance with a specific charge.

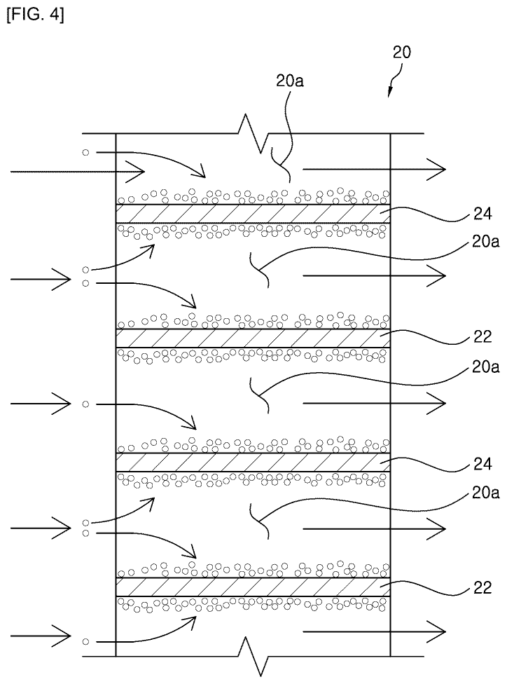

Therefore, as shown in FIG. 4, the first and second electrode plates 22 and 24 can alternately collect foreign substances of a specific charge that are introduced into the air flow path 20a between them.

Accordingly, both the first electrode plate 22 and the second electrode plate 24 can be used as dust collection parts, and hence, the ability to remove foreign substances in the air blown into the vehicle interior can be improved by about two times.

In addition, since both the first electrode plate 22 and the second electrode plate 24 can collect foreign substances, the product's lifespan is significantly extended compared to the prior art in which only one of the first and second electrode plates 22 and 24 is used as a dust collection part.

At this time, even if the polarities of the first and second electrode plates 22 and 24 are periodically reversed, the foreign substances captured on the first and second electrode plates 22 and 24 remain attached to the surfaces of the first and second electrode plates 22 and 24 by the van der Waals force.

Referring again to FIGS. 2 and 3, the control part 30 periodically reverses the magnitudes of the voltages applied to the first and second electrode plates 22 and 24 through a structure that controls the voltages applied to the first and second electrode plates 22 and 24 in opposite directions.

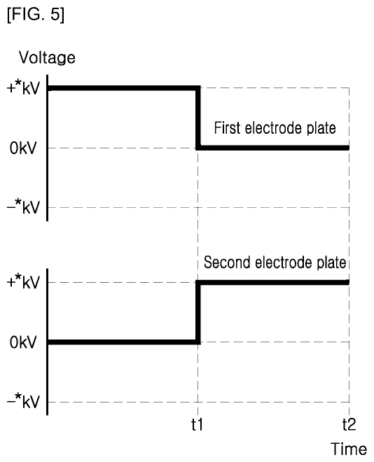

For example, as illustrated in FIG. 5, a specific positive voltage +kV is applied to one of the first and second electrode plates 22 and 24, and a ground voltage 0 kV is applied to the other. The specific positive voltage +kV and the ground voltage 0 kV are controlled to be applied to the first and second electrode plates 22, 24 alternately at preset time intervals t.

Accordingly, the magnitudes of the voltages applied to the first and second electrode plates 22 and 24 can be periodically reversed.

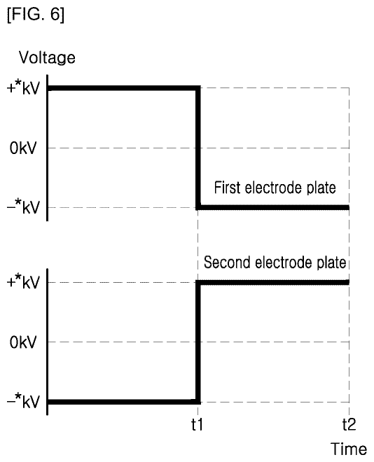

As shown in FIG. 6, a specific positive voltage +kV is applied to one of the first and second electrode plates 22 and 24, and a specific negative voltage −kV is applied to the other. The specific positive voltage +kV and the specific negative voltage −kV are controlled to be applied to the first and second electrode plates 22 and 24 alternately at preset time intervals t.

Accordingly, the magnitudes of the voltages applied to the first and second electrode plates 22 and 24 can be periodically reversed.

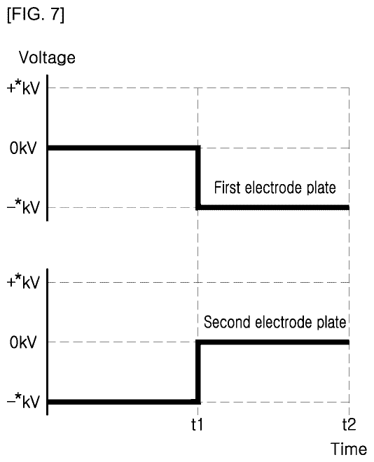

As shown in FIG. 7, a ground voltage of 0 kV is applied to one of the first and second electrode plates 22 and 24, and a specific negative voltage of −kV is applied to the other. The ground voltage of 0 kV and the specific negative voltage of −kV are controlled to be applied to the first and second electrode plates 22 and 24 alternately at preset time intervals of t.

Accordingly, the magnitudes of the voltages applied to the first and second electrode plates 22 and 24 can be periodically reversed.

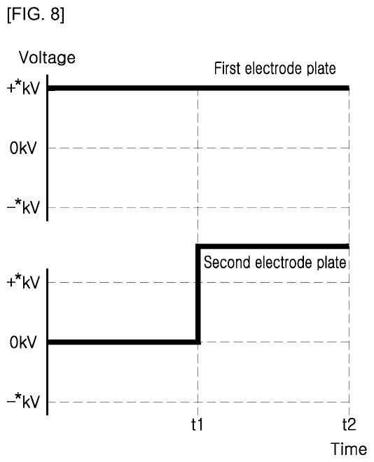

Meanwhile,, as shown in FIGS. 8 to 11, the control part 30 may periodically reverse the magnitudes of the voltages applied to the first and second electrode plates 22 and 24 while maintaining the magnitude of the voltage applied to one of the first and second electrode plates 22 and 24 at a constant value and variably controlling only the magnitude of the voltage applied to the other.

In particular, while maintaining the magnitude of the voltage applied to the first electrode plate 22 at a constant voltage, only the magnitude of the voltage applied to the second electrode plate 24 may be controlled to be alternately higher and lower than the magnitude of the voltage applied to the first electrode plate 22 at preset time intervals t.

For example, as shown in FIG. 8, while constantly maintaining the voltage applied to the first electrode plate 22 at a specific positive voltage +kV, the voltage applied to the second electrode plate 24 is controlled to be alternately changed to a ground voltage 0 kV and a specific positive voltage +kV higher than the voltage +kV applied to the first electrode plate 22 at preset time intervals t.

Therefore, based on the specific positive voltage +kV, which is the voltage applied to the first electrode plate 22, the voltage applied to the second electrode plate 24 can be controlled to be alternately changed to a ground voltage 0 kV lower than the voltage applied to the first electrode plate 22, and a specific positive voltage +kV higher than the voltage applied to the first electrode plate 22 at preset time intervals t.

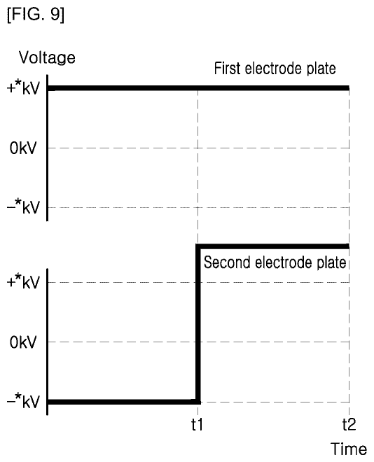

Alternatively, as shown in FIG. 9, while constantly maintaining the voltage applied to the first electrode plate 22 at a specific positive voltage +kV, the voltage applied to the second electrode plate 24 is controlled be alternately changed to a specific negative voltage −kV and a specific positive voltage +kV higher than the voltage +kV applied to the first electrode plate 22 at preset time intervals t.

Therefore, based on the specific positive voltage +kV of the anode, which is the voltage applied to the first electrode plate 22, the voltage applied to the second electrode plate 24 can be controlled to be alternately changed to a specific negative voltage −kV lower than the voltage applied to the first electrode plate 22 and a specific positive voltage +kV higher than the voltage applied to the first electrode plate 22 at preset time intervals t.

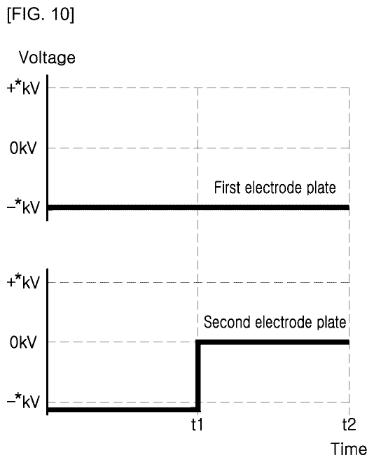

Alternatively, as shown in FIG. 10, while constantly maintaining the voltage applied to the first electrode plate 22 at a specific negative voltage-kV, the voltage applied to the second electrode plate 24 is controlled to be alternately changed to a specific negative voltage −kV lower than the voltage −kV applied to the first electrode plate 22 and a ground voltage 0 kV higher than the voltage −kV applied to the first electrode plate 22 at preset time intervals t.

Therefore, based on the specific negative voltage −kV, which is the voltage applied to the first electrode plate 22, the voltage applied to the second electrode plate 24 can be controlled to be alternately changed to a specific negative voltage −kV lower than the voltage applied to the first electrode plate 22 and a ground voltage 0 kV higher than the voltage applied to the first electrode plate 22 at preset time intervals t.

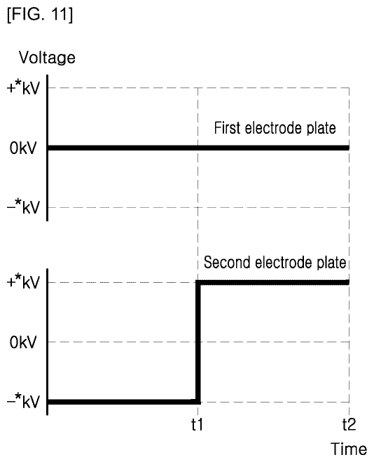

Alternatively as shown in FIG. 11, while constantly maintaining the voltage applied to the first electrode plate 22 at a ground voltage 0 kV, the voltage applied to the second electrode plate 24 is controlled to be alternately changed to a specific negative voltage −kV lower than the voltage 0 kV applied to the first electrode plate 22 and a specific positive voltage +kV higher than the voltage 0 kV applied to the first electrode plate 22 at preset time intervals t.

Therefore, based on the ground voltage 0 kV, which is the voltage applied to the first electrode plate 22, the voltage applied to the second electrode plate 24 can be controlled to be alternately changed to a specific positive voltage −kV lower than the voltage applied to the first electrode plate 22 and a specific positive voltage +kV higher than the voltage applied to the first electrode plate 22 at preset time intervals t.

In this embodiment, the control part 30 changes the voltages applied to the first and second electrode plates 22 and 24 periodically at preset time intervals. However, in some cases, the control part 30 may also change the voltages based on other logic.

For example, the control part 30 may change the voltages applied to the first and second electrode plates 22 and 24 when the accumulated amount of foreign substances captured by one of the first and second electrode plates 22 and 24 currently capturing foreign substances is equal to or greater than a preset reference value.

At this time, the accumulated amount of foreign substances captured by each of the first and second electrode plates 22 and 24 is detected by measuring the electrostatic capacitance of each of the first and second electrode plates 22 and 24.

In addition, the control part 30 may change the voltages applied to the first and second electrode plates 22 and 24 when the accumulated foreign substance capture time of one of the first and second electrode plates 22 and 24 currently capturing foreign substances is equal to or greater than a preset reference value.

In addition, the control part 30 may change the voltages applied to the first and second electrode plates 22 and 24, and may process information factors such as the accumulated amount of foreign substances captured by one of the first and second electrode plates 22 and 24 currently capturing foreign substances, the accumulated foreign substance capture time, and the concentration of fine dust in the outside air using a pre-installed logic to calculate an optimal change time.

When the accumulated foreign substance capture time of one of the first and second electrode plates 22 and 24 currently capturing foreign substances exceeds the optimal change time, the voltages applied to the first and second electrode plates 22 and 24 can be changed.

According to the electric dust filter of the present invention having such a configuration, the voltages applied to the first and second electrode plates 22 and 24 are controlled to periodically reverse the polarities of the first and second electrode plates 22 and 24, thereby alternately controlling the attractive force of the first and second electrode plates 22 and 24 for foreign substances having a specific charge.

Accordingly, both the first and second electrode plates 22 and 24 can alternately collect foreign substances in the air blown into the vehicle interior.

In addition, since both the first and second electrode plates 22 and 24 can be used as dust collection parts, the ability to remove foreign substances in the air blown into the vehicle interior can be improved by about two times.

In addition, since both the first and second electrode plates 22 and 24 can collect foreign substances, it is possible to extend the life of the product and to reduce the manufacturing cost compared to the prior art in which only one of the first and second electrode plates 22 and 24 is used as a dust collection part.

While the preferred embodiments of the present invention have been described above by way of example, the scope of the present invention is not limited to such specific embodiments, and may be appropriately changed within the scope recited in the claims.

1. An electric dust filter, comprising:
a dust collection part configured to collect foreign substances charged with a specific charge among negative and positive charges, the dust collection part including first and second electrode plates installed in one or more pairs on an air flow path leading to a vehicle interior so as to form an air flow path therebetween, the first and second electrode plates configured to generate an electric field in a specific direction therebetween using voltages with different magnitudes and collect foreign substances having a specific charge by an attractive force; and
a control part configured to variably control the magnitudes of voltages applied to the first and second electrode plates according to a preset logic so that the attractive forces of the first and second electrode plates for the foreign substances having a specific charge can be alternately changed while reversing the direction of the electric field formed between the first and second electrode plates.

2. The electric dust filter of claim 1, wherein, depending on the direction of the electric field due to a voltage difference between the first and second electrode plates, one of the first and second electrode plates has the same polarity as the foreign substances having a specific charge so as to generate a repulsive force while the other has a polarity different from the polarity of the foreign substances having a specific charge so as to generate an attractive force, and
the control part is configured to apply a high voltage to one of the first and second electrode plates and a relatively low voltage to the other, and change the magnitudes of voltages applied to the first and second electrode plates according to a preset logic to reverse the direction of the electric field due to the voltage difference between the first and second electrode plates.

3. The electric dust filter of claim 2, wherein the control part is configured to independently control the voltages applied to the first and second electrode plates to change the magnitudes of the voltages applied to the first and second electrode plates.

4. The electric dust filter of claim 3, wherein the control part is configured to apply a specific positive voltage +kV to one of the first and second electrode plates and a ground voltage 0 kV to the other and is configured to alternately apply the specific positive voltage 0+kV and the ground voltage 0 kV to the first and second electrode plates to reverse the magnitudes of the voltages applied to the first and second electrode plates.

5. The electric dust filter of claim 3, wherein the control part is configured to apply a specific positive voltage +kV to one of the first and second electrode plates and a specific negative voltage −kV to the other and is configured to alternately apply the specific positive voltage +kV and the specific negative voltage −kV to the first and second electrode plates to reverse the magnitudes of the voltages applied to the first and second electrode plates.

6. The electric dust filter of claim 3, wherein the control part is configured to apply a ground voltage 0 kV to one of the first and second electrode plates and a specific negative voltage −kV to the other and is configured to alternately apply the ground voltage 0 kV and the specific negative voltage −kV to the first and second electrode plates to reverse the magnitudes of the voltages applied to the first and second electrode plates.

7. The electric dust filter of claim 2, wherein the control part is configured to maintain the voltage applied to one of the first and second electrode plates at a constant value and variably control only the voltage applied to the other to reverse the magnitudes of the voltages applied to the first and second electrode plates.

8. The electric dust filter of claim 7, wherein the control part is configured to maintain the voltage applied to the first electrode plate at a specific voltage and alternately change only the voltage applied to the second electrode plate to a voltage lower than the voltage applied to the first electrode plate and a voltage higher than the voltage applied to the first electrode plate to reverse the magnitudes of the voltages applied to the first and second electrode plates.

9. The electric dust filter of claim 8, wherein the control part is configured to maintain the voltage applied to the first electrode plate at a specific positive voltage +kV and alternately change the voltage applied to the second electrode plate to a ground voltage 0 kV lower than the voltage applied to the first electrode plate and a specific positive voltage +kV higher than the voltage +kV applied to the first electrode plate to reverse the magnitudes of the voltages applied to the first and second electrode plates.

10. The electric dust filter of claim 8, wherein the control part is configured to maintain the voltage applied to the first electrode plate at a specific positive voltage +kV and alternately change the voltage applied to the second electrode plate to a specific negative voltage −kV lower than the voltage applied to the first electrode plate and a specific positive voltage +kV higher than the voltage +kV applied to the first electrode plate to reverse the magnitudes of the voltages applied to the first and second electrode plates.

11. The electric dust filter of claim 8, wherein the control part is configured to maintain the voltage applied to the first electrode plate at a specific negative voltage −kV and alternately change the voltage applied to the second electrode plate to a specific negative voltage −kV lower than the voltage −kV applied to the first electrode plate and a ground voltage 0 kV higher than the voltage −kV applied to the first electrode plate to reverse the magnitudes of the voltages applied to the first and second electrode plates.

12. The electric dust filter of claim 8, wherein the control part is configured to maintain the voltage applied to the first electrode plate at a ground voltage 0 kV and alternately change the voltage applied to the second electrode plate to a specific negative voltage −kV lower than the voltage 0 kV applied to the first electrode plate and a specific positive voltage +kV higher than the voltage 0 kV applied to the first electrode plate to reverse the magnitudes of the voltages applied to the first and second electrode plates.

13. The electric dust filter of claim 1, wherein the control part is configured to periodically change the voltages applied to the first and second electrode plates at preset time intervals.

14. The electric dust filter of claim 1, wherein the control part is configured to change the voltages applied to the first and second electrode plates when the accumulated amount of foreign substances captured by one of the first and second electrode plates currently capturing foreign substances is equal to or greater than a preset reference value.

15. The electric dust filter of claim 1, wherein the control part is configured to change the voltages applied to the first and second electrode plates when the accumulated foreign substance capture time of one of the first and second electrode plates currently capturing foreign substances is equal to or greater than a preset reference value.

16. The electric dust filter of claim 1, wherein the control part is configured to process the accumulated amount of foreign substances captured by one of the first and second electrode plates currently capturing foreign substances, the accumulated foreign substance capture time, and the concentration of fine dust in outside air using a pre-installed logic to calculate an optimal change time, and is configured to change the voltages applied to the first and second electrode plates when the accumulated foreign substance capture time of one of the first and second electrode plates currently capturing foreign substances exceeds the optimal change time.
